(19) United States
(12) Patent Application Publication
(10) Pub. No.: US 2007/0021992 A1
(43) Pub. Date: Jan. 25, 2007

(54) Method and system for generating a business intelligence system based on individual life cycles within a business process

(76) Inventor: Srinivas Konakalla, Cupertino, CA (US)

Correspondence Address: Evergreen Valley Law Group, Suite 275, 2670 S. White Road, San Jose, CA, 95148, US

(21) Appl. No.: 11/185,074

(22) Filed: Jul. 19, 2005

(51) Int. Cl. G06F 9/44

(52) U.S. Cl. 705/7

(57) ABSTRACT

The present invention relates to a method and system for generating a comprehensive Business Intelligence system based on a lifecycle approach that comprises of the steps of: modeling, building, generating and analyzing in order to analyze a business process end to end. In accordance with the present invention, modeling comprises the steps of defining a business process life cycle and its metrics and splitting each Business process lifecycle into several events or stages. This step also includes facilitating gathering of business requirements and developing a project plan based on them. The step of building comprises building the Business Intelligence system by interconnecting events or stages of BP lifecycles within the business process. The step of generating comprises the step of generating the Business Intelligence system in one shot by displaying the interconnectivity of various Business process lifecycles within the business process. The step of analyzing provides an easy to use web interlace to analyze business process life cycles based on the metrics and dimensions defined by business users.

### BACKGROUND OF THE INVENTION

1. Field of the Invention The invention relates generally to the field of business intelligence systems. More particularly, this invention relates to a method and system for generating a business intelligence system based on stages or events within individual life cycles comprising a business process.

2. Description of Related Art

Over the past two decades companies have invested heavily in automating their business and processes by implementing ERP, CRM, BPM and other enterprise software applications to gain competitive edge. These applications have improved the productivity of the companies resulting in reduced costs and gaining competitive edge. However, most companies have implemented these applications resulting in less differentiation between companies. So, the next step in gaining competitive advantage is to improve the business processes by analyzing the data collected in the enterprise software applications and optimizing the business processes.

The present invention relates to structuring business process analysis right from designing and modeling, to integrating and automating, to deploying and executing, and to measuring and optimizing the business process to allow businesses to take control of their data, stay informed and optimize using business intelligence methodologies. This invention defines a method to combine business process and business intelligence—BPI.

### SUMMARY OF THE INVENTION

The present invention relates to a method and system for generating a comprehensive Business Intelligence system based on a business process lifecycle approach that comprises of the steps of: modeling, building, generating and analyzing in order to analyze a business process end to end. In accordance with the present invention, modeling comprises the steps of defining a business process, splitting the business process into small quantifiable life cycles, further decompose each business process lifecycle into several events or stages and define the associated metrics for the life cycle and stages. This step also includes facilitating gathering of business requirements and developing a project plan based on them. The step of building comprises building the Business Intelligence system by interconnecting events or stages of business process lifecycles within the business process. The step of generating comprises the step of generating the Business Intelligence system in one shot by displaying the interconnectivity of various Business process lifecycles within the business process and the associated software application. The step of analyzing provides an easy to use web interface to analyze business process life cycles based on the metrics and dimensions defined by business users.

It is an advantage of the present invention to provide a Business Intelligence system that is a comprehensive Business Process Intelligence solution that is derived from blending both Business Process Management and Business Intelligence.

Another advantage of the present invention is to allow businesses to get a better value from their investments in terms of generating Business Intelligence solutions.

Another advantage of the present invention is to generate a comprehensive Business Intelligence system that provides improved efficiency for businesses.

It is yet another advantage of the present invention to aid with corporate compliance by generating an end to end visibility of the lowest detail at the corporate level that can assist in Sarbanes Oxley compliance.

It is an objective of the present invention to provide a Business Intelligence system that is a comprehensive Business Process Intelligence solution that is derived from blending both Business Process Management and Business Intelligence.

Another objective of the present invention is to allow businesses to get a better value from their investments in terms of generating Business Intelligence solutions.

Another objective of the present invention is to generate a comprehensive Business Intelligence system that provides improved efficiency for businesses.

It is yet another objective of the present invention to aid with corporate compliance by generating an end to end visibility of the lowest detail at the corporate.

### BRIEF DESCRIPTION OF THE DRAWINGS

FIG. 1 is a block diagram illustrating the sequence of steps involved in the generation of a Business Intelligence system within an enterprise.

FIG. 2 is a flow chart illustrating the sequence of steps involved in modeling a business process towards the generation of a comprehensive Business Intelligence system.

FIG. 3 is a flow chart illustrating the sequence of steps involved in building a comprehensive Business Intelligence system.

FIG. 4 is a flow chart illustrating the sequence of steps involved in generating a comprehensive Business Intelligence system.

FIG. 5 is a flow chart illustrating the sequence of steps involved in analyzing a business process and life cycles to optimize it.

### DETAILED DESCRIPTION OF THE INVENTION

Business process benchmarking has become a competitive strategic element that affects business partners, individual customers, employee morale, productivity and profitability. Applying Business Intelligence to Business processes and paving paths to Business Process Intelligence has become a determining factor for the success of an organization. The many business processes that run an organization are not isolated systems, but include a maze of life cycles connected to each other. Organizational structure throughout the many diverse industries varies but for the most part, all organizations have similar business processes. It is necessary that business and IT users understand the way these processes are, and apply techniques that result in Business Process intelligence and not just Business Intelligence. Converging Business Intelligence and Business Process helps business analysts continuously and consistently monitor and measure business processes through all phases and with all permutations and combinations to tune and optimize them.

For example there are a number of high level business processes like customer relationship management, supply chain management, production management, financials management and so on, which run a business organization. All these business processes have a number of small quantifiable life cycles to guide the flow of action through a series of activities.

For instance, a business process such as CRM comprises of numerous lifecycles such as Lead to Order, Request to Service etc., The Lead to Order—L2O in turn is made up of Lead, Opportunity, Quote, and Order stages and. the Request to Service-R2S, lifecycle comprises of Switch, Agent/Customer interaction, Customer repair and survey stages.

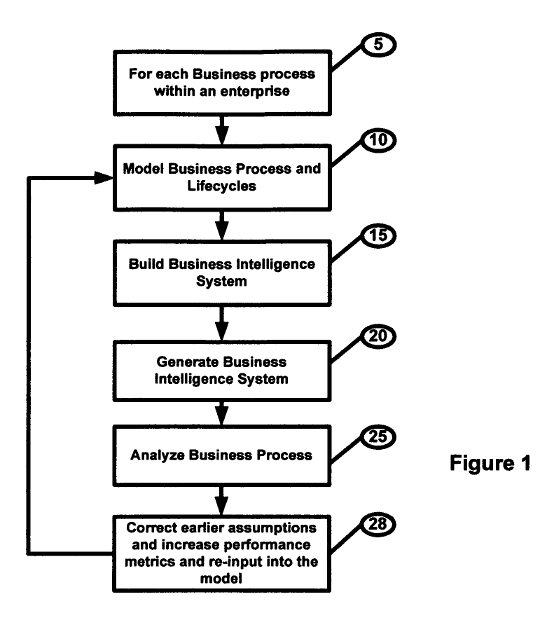

FIG. 1 is a block diagram illustrating the sequence of steps involved in the generation of a Business Intelligence system within an enterprise using business processes.

In accordance with a preferred embodiment of the present invention, the generation of the Business Intelligence system is an iterative process with a feedback loop and is dependent on the business processes. In a preferred embodiment of the present invention, for each business process within an enterprise (step 5) the process of generation of a Business Intelligence system starts with modeling the Business Process (step 10) followed by building the Business Intelligence System (step 15). This is followed by generating the Business Intelligence systems (step 20) followed by an analysis of the Business process (step 25). The process concludes with correcting earlier assumptions about performance of the business process and increasing performance metrics and through a re-input of those metrics into the business process (step 28.)

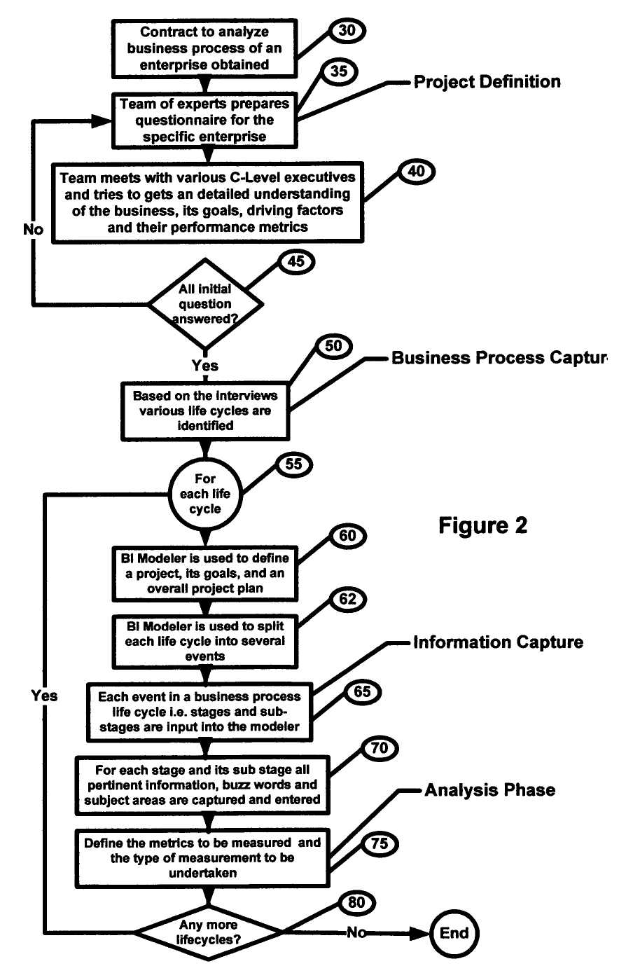

FIG. 2 is a flow chart illustrating the sequence of steps involved in modeling a business process towards the generation of a comprehensive Business Intelligence system.

Modeling

In accordance with a preferred embodiment of the present invention, a business process analysis starts with modeling the business processes. The modeling step allows a business analyst to capture the broad outline and procedures that govern what it is that a business does. Modeling allows integration of the regular tasks undertaken by a Business with the business processes through insight-driven actions. Modeling helps define business processes, process life cycles, specific inputs and outputs, resources consumed, chronology of activities performed and the events that drive the overall process.

Business process modeling may affect more than one organizational unit. So modeling a business process requires well developed, user-friendly tools and interfaces to structure the business process. Moreover, business process modeling requires a business-centric approach and not a techno-centric view. The business process modeler should be designed to meet the business requirements of business users but not IT staff.

In accordance with a preferred embodiment of the present invention, Modeler helps organizations visualize, analyze and improve business processes. A business process modeler provides business analysts and IT developers with an easy to use way to model their business value of IT solutions by allowing business analysts to tie corporate initiatives and goals to business requirements and processes. A modeler helps design a more comprehensive business model, achieve goal oriented business modeling, model a business process life cycle and stages, define overall metrics for the business process life cycle, define individual life cycle stage metrics, generate requirements documentation and develop applications to real-life organizations.

In accordance with a preferred embodiment of the present invention, a business process Modeler has five integrated modules:
1. Project module: A business process model is typically designed for a particular process or a group of processes in an organization. Business analysts are expected to define this process before starting with the actual modeling. And a business process also has some well-defined goals to justify these actions. The project module has separate sections i.e. the Define project; define goals and project plan that serve to capture the information related to the project undertaken, its goals, and the plan of action for achieving those goals respectively.
2. Business process module: A business process is a flow of activities structured to result in a particular output for a particular market. Thus, a business process comprises of at least one lifecycle and generally a plurality of lifecycles. A business process thus orders the work activities across time and place, with a beginning, and an end and clearly defined inputs and outputs. The life cycle stages defined in the business process module of the Modeler prepare the ground for a structured action, users and the required stages and sub stages in the life cycle section of the business process.
3. Information capture module: A business process needs information in the form of inputs and resources, which can be utilized in the process of realizing a particular task. The information is collected to produce some output of business values that ultimately serves the purpose of business analysis either for internal use or to fulfill an external requirement.

The modeler captures these inputs in the Information capture module. The information category helps describe the primary business behind the particular information collected. Buzzwords and subject areas reflect the core of the business. The requirements section helps the users plan the report requirements of a business analyst.
4. Analysis module: The analysis module helps define the metrics and how these metrics are analyzed. This in turn enables a business analyst to draw sophisticated and reliable conclusions about the business process.
5. Documentation module: This module is document generation tool developed to help users generate documentation of any project, business process. life cycle and their associated requirements.

In accordance with a preferred embodiment of the present invention, the process of modeling a Business process comprises of several steps illustrated as follows. In step 30, a contract to analyze the business process of an enterprise is obtained. In step 35, a team of experts prepares questionnaire tailor made for the specific enterprise and its business process is prepared. In step 40, the team meets with various C-Level executives within the enterprise to obtain a detailed understanding of the business, its goals, driving factors and their performance metrics. Once the team's questions have been answered (step 45) and based on the output from these interviews various life cycles within the Business process are identified (step 50.) For each life cycle, modeling is done to define the project, its goals and an overall project plan (step 60.) In step 62, each business process lifecycle is split into several events or stages. In step 65, all business activities (stages) and their dependencies (sub stages) are input into the modeler. In step 70, for each stage and its sub stage all pertinent information, buzz words and subject areas are captured and entered. In step 75, the dimensions and facts to be measured and the type of measurement to be undertaken are defined (step 75.) If there are no more life cycles (step 80) the modeling process is concluded.

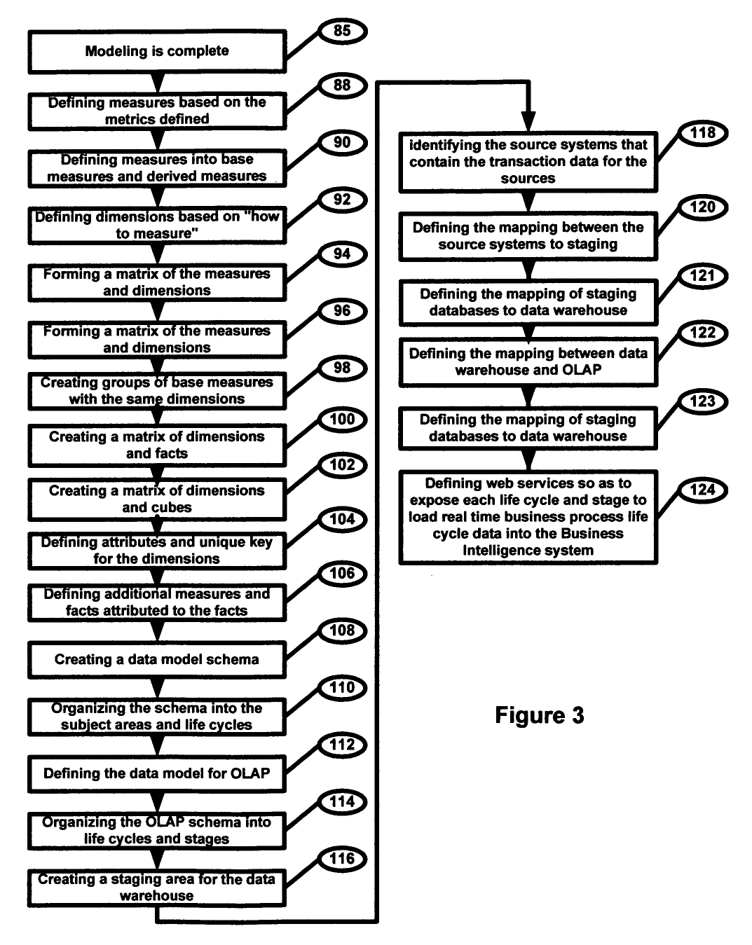

FIG. 3 is a flow chart illustrating the sequence of steps involved in translating a business process into building a comprehensive Business Intelligence system.

Build

Business process life cycle analysis does not end with modeling the business processes. The business processes have to be integrated with process-level metrics, which determine business process performance. A business analyst has to seek the help of several technologies and approaches in order to bridge the gap between processes and their performance levels for business process analysis. This is a transition phase where the process and performance level metrics are turned into operational task recommendations for optimizing performance and actions.

Business intelligence system building needs a collaborative effort of IT professionals. business analysts, and solutions providers. The effort demands a sound knowledge of data warehousing, OLAP, business intelligence, and other information analysis techniques. Further, one needs to have a level of business insight to understand how a business intelligence system supports informed decision-making.

Business Intelligence building enables an organization to scope out and agree on information requirements for several business processes. It involves different sets of organizational users, as analysts review data requirements across business areas, determine common patterns of data usage and develop a data model that is representative of the enterprise.

The building component includes several modules such as:
1. Model analysis module: This module analyzes the requirements of the business process as defined in the modeler. This analysis of the business requirements enables identification and classification of the relationships among the data objects and also helps in determining the types of transactions that will be executed on the database and the interactions between the data and the transactions. These data objects are typically called dimensions and measures in the business intelligence world. The model analysis provides a step by step wizard to translate the business process requirements into a business intelligence data model that includes data warehouse, OLAP and any other database objects.
2. Sources module: The sources module helps gather the inputs from different databases, flat files and other types of data. It identifies the origins of the data collected to satisfy the requirements specified by the business users in the Modeler.
3. Staging module: This module lies mid-tier between sources and data warehouse. This module cleans, combines, archives and eventually exports data to one or more data marts and keeps the data ready for loading into data warehouse.
4. Data Warehouse module: This module structures the database for query, analysis and reporting and gives a physical shape for the relationships that have been identified and classified during the model analysis module and receives data from heterogeneous On-Line Transaction Processing (OLTP) systems that are defined in the SOURCE module and organizes it for extraction by On-Line Analytical Processing (OLAP) systems. In this module users will define a data warehouse data model using step by step and graphical modeling methods.
5. OLAP: OLAP is a technological method adopted for extracting business information i.e. organized into “dimensions” such as product, sales territory, customers and sales period. OLAP assures that users drill deeper into the information details for greater insight into several business trends. The OLAP module helps users define the OLAP data model that works with any OLAP database available.
6. ETL module: Extraction, transformation and load (ETL) module allows movement of data from multiple sources (Sources module), reformatting of data and cleanse data (staging module) and eventually loading it into a data warehouse (data warehouse module.). The ETL module will help users create an ETL specifications, map the source data objects to the target data objects to generate the ETL services (software programs) to load the target data objects in either the staging, data warehouse, OLAP or other database.
7. Web services module: Web services platform provide services for automating large portions of business processes in order to speed up the development of the application life cycle and also helps in negotiating with multiple suppliers, customers and business partners. The web services module will allow users to define the web services needed to load the data real time and expose the data for external software programs to access.
8. UI Module: In the UI module the users will define the front end web application where business users will analyze the business processes and optimize them.
9. Documentation module: The documentation module helps users to generate custom or end to end documentation of the Business Intelligence system as defined in the Builder tool.

Once modeling is concluded (step 85), Business Intelligence architect defines the measures based on the metrics defined in model analysis (step 88.) In step 90, the measures are defined into base and derived measures. In step 92, Business Intelligence architect defines the dimensions based on “how to measure”. In step 94, a matrix of the measures and dimensions is formed. In step 96, groupings of base measures that have the same dimension are created. In step 98, groupings of derived measures that have the same dimension are created. In step 100, a matrix of dimensions and facts is created and are associated with the model analysis. In step 102, a matrix of dimensions and cubes is created and are associated with the model analysis. In step 104, attributes and unique key for the dimensions are defined. In step 106, additional measures and facts attributed to the facts are defined. In step 108, a data model schema is created. It would be known to those of ordinary skill in the art that the data model so created may be in any format including star or snowflake. In step 110, the schemas are organized into subject areas and life cycles. In step 112, the data model for the OLAP is defined. In step 114, the OLAP schema is organized into life cycles and stages. In step 116, a staging area for the data warehouse is created. In step 118, the source systems that contain the transaction data for the sources is identified. In step 120, the mapping between the source systems to staging is defined followed by a defining of the mapping of staging database to data warehouse (step 121.) In step 122, the mapping between data warehouse and OLAP is defined. In step 123, web services are defined so as to expose each life cycle and stage. In step 124, web services are defined to load real time business process life cycle data into the Business Intelligence system.

It will be known to those of ordinary skill in the art that based on the specific needs some of the steps can be by passed and a data warehouse created.

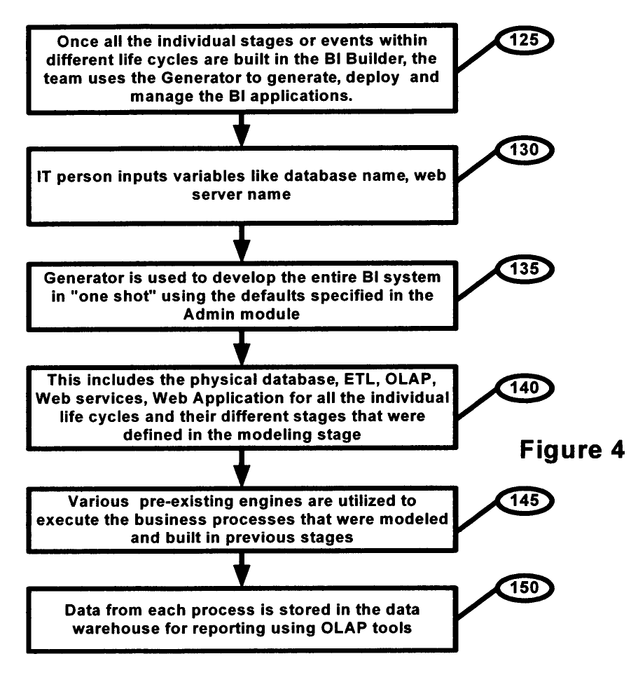

FIG. 4 is a flow chart illustrating the sequence of steps involved in generating and deploying a comprehensive Business Intelligence system based on business process.

Generate

Business intelligence applications are built to be available for business process analysis. So it is necessary that applications be generated and deployed in order to initiate the application execution. The term generating means automating high volume of complex services with unmatched performance.

In order to facilitate analysis of applications run using business analysis queries, an underlying functionality is needed to bring in raw data from several sources followed by consolidation, organization and standardize of information in repositories such as data warehouses and data marts.

In accordance with a preferred embodiment of the present invention. Generator includes a number of engines which provide innumerable services for executing and managing business process applications, and a repository of a relational database and/or OLAP database that may run on any platform.

The generator includes several engines listed below:
1. ETL generator: The ETL engine is a runtime engine that executes predefined ETL (Extract, Transform, and load) processes. The data links of the engine take the data from the sources and send them to the target areas. The ETL generator generates the services based on the design and specifications defined in the ETL module of the builder.
2. Portal generator: The portal generator generates a web application as defined in the UI module of the builder. This web application allows the users to analyze the business process as detailed in the Analyzer section of this document.
3. Meta data generator: Meta data is the data that describes the entire business process intelligence solution. This includes both business and technical meta data. The business meta data are terms that describe business process, life cycles, metrics etc. The technical meta data the design and the terms defined in the builder. This meta data generator generates the meta data based on the design in the Modeler, Builder and Generator modules.
4. Reference Data Generator: Reference data is essentially the data that helps the users to analyze the metrics. These are the “how to measure” data defined in the Modeler and the dimensions defined in the Builder. The reference data generator generates the screens to update the reference data in the analyzer based on the security restrictions.
5. OLAP generator: facilitates for generating cubes, dimensions and other OLAP objects needed for the OLAP database.
6. Data warehouse generator: Generates the physical database needed for the data warehouse database to support the business requirements.
7. Source engine: Generates the software services needed to support the extraction of data from the source systems and load it into the data warehouse, OLAP and other required database.
8. Web Service Generator: This generator generates the web services for both loading the business intelligence system with the data and also exposing the data in the data warehouse and OLAP databases to external programs.

In accordance with a preferred embodiment of the present invention, Generator generates the software programs, services and applications needed to deploy and run business intelligence system to support the business process requirements.

In accordance with a preferred embodiment of the present invention, the step of generating comprises of a sequence of steps stated as follows. In step 125, once all the individual stages within different life cycles are built in the Business Intelligence Builder, the Generator is used to generate, deploy and manage the Business Process Intelligence applications. In step 130, an IT person inputs variables such as database name and web server name and so on. In step 135, generator is used to develop the entire Business Intelligence system in one shot using defaults specified in the Admin module. This one shot generation of tile Business Intelligence system includes the database schema for all the individual life cycles and their different stages that were defined in the modeling stage (step 140.) The ETL engine is a runtime engine that executes predefined ETL (Extract, Transform, and Load) processes. The data links of the engine take the data from the sources and send them to the target areas. The portal generator generates a web application as defined in the UI module of the builder. This web application allows the users to analyze the business process as detailed in the Analyzer section of this document.

The meta data generator generates the meta data based on the design in the Modeler, Builder and Generator modules. The reference data Generator generates the “how to measure” data defined in the Modeler and the dimensions defined in the Builder. The reference data generator generates the screens to update the reference data in the analyzer based on the security restrictions. The OLAP generator facilitates generation of cubes, dimensions and other OLAP objects needed for the OLAP database. The data warehouse generator generates the physical database needed for the data warehouse database to support the business requirements. The source engine generates the software services needed to support the extraction of data from the source systems and load it into the data warehouse, OLAP and other required database. The Web Service Generator generates the web services for both loading the business intelligence system with the data and also exposing the data in the data warehouse and OLAP databases to external programs. In step 150, data from each process is stored in the data warehouse for reporting using OLAP tools.

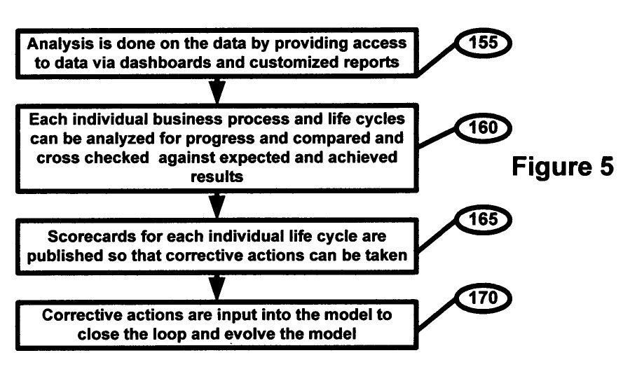

FIG. 5 is a flow chart illustrating the sequence of steps involved in analyzing a business process and life cycles to optimize it.

Analyze

The ultimate purpose of modeling business processes and building and generating business intelligence systems is to analyze the performance of business processes and take right actions at the right time. Business process analysis helps you to measure business performance against certain internal and external benchmarks.

In the present economic scenario businesses need that extra leverage, which keeps them at par with the changing conditions. Business objectives such as forecasting, customer profiling, trend analysis and fraud detection can be realized through aggressive analysis tools. The analysis tools and applications provide real-time reporting and scorecard rating privileges.

The step of analyzing comprises of manipulating and comparing data, analyzing the required business stages, creating visual representation of multiple data points immediately in chart, graph and table formats through the reporting tool, choosing pertinent data and performing the needed statistical summaries and calculations, answering all business queries with OLAP capabilities; assessing business performance and indicating ratings through the appropriate module, transforming the multi-dimensional data into actionable information.

In accordance with a preferred embodiment of the present invention, the analyzer comprises of several modules listed as below:
1. Dashboard module: creates role-based dashboards that provide end users with information or data relevant to their individual roles. An intuitive platform of Dashboard allows gathering of data from numerous sources and presentation within a single location. The graphical interface of the Dashboard presents complex data in easily understandable visual formats and allows users to click on charts and links, drill down to detailed information and analyze the data. The dashboards are generally related to a business process, life cycle or stages. However, the users have the flexibility to create custom dashboards that are unique to their needs.
2. Analysis module: This module allows the users to analyze the business processes and life cycles using the metrics defined in the modeler. Users can create custom views to to suit their specific analysis requirements. For example: A leads and orders analyzer view will show the conversion ratio of leads to orders so that the business can really measure and optimize how well the Lead to Order business process life cycle is functioning in a company.
3. Scorecard module: This module rates the business performance from year to year, from product to product, from service to service etc., against some pre-defined goals defined by the business. Users have the flexibility to create either business processes/life cycle or custom scorecards. Potential problem areas in a business process are highlighted using traffic lighting—red, green and yellow color coding.
4. Reference data module: In this module, data grid displays and edits the dimensions and facts based on the security privileges defined in the administrator module.
5. Meta data module: This module adds edits and displays the business and technical metadata i.e., data that describes the entire business process intelligence solution.
6. Reporting module: The reporting provides users with the ability to create detailed reports surrounding the metrics to analyze the business process. A rich set of graphical features are provided so that users can create custom reports.
7. Alerts module: Alerts assist businesses to become proactive rather than reactive. They warn businesses of the loopholes and the existing dangers. The alerts module allows business users to define a set of business rules and notify them of exceptions either via email, sms etc.
8. Configuration module: This module allows an analyzer user to customize the generated analyzer application according to his or her needs. This includes to and not limited to the look and feel, security etc.

In accordance with a preferred embodiment of the present invention, the step of analyzing comprises of a series of steps which are outlined as follows. In step 155, analysis is done on the data stored in the data warehouse by providing access to data via dashboards and customized reports for the business processes and life cycles . . . In step 160 each individual life cycle can be analyzed for progress and compared and cross checked with expected and achieved results. In step 165, scorecards are published for each individual life cycle so that corrective actions can be taken. In step 170, corrective actions are input into the model to close the loop and evolve the Business Intelligence model.

Although the present invention has been particularly shown and described above with reference to specific embodiments, it is anticipated that alterations and modifications thereof will no doubt become apparent to those skilled in the art. It is therefore intended that the following claims be interpreted as covering all such alterations and modifications as fall within the true spirit and scope of the invention.

1. A method of generating a Business Intelligence system in one shot comprising the steps of:
modeling a business process by defining at least one business process lifecycle by splitting said business process lifecycle into several events and by defining its metrics and dimensions;
building the business intelligence system by interconnecting business process life cycles within the business process;
generating the business intelligence system in one shot by showing the interconnectivity of various business process life cycles within the business process; and
analyzing entire business processes based on the Business Intelligence system generated.

2. The method of claim 1, wherein the step of modeling further comprises:
obtaining an understanding of the business process requirements;
identifying individual business process lifecycles within the business process;
adding stages and sub stages in life cycles by capturing information related to each stage and sub stage; and
analyzing the information captured.

3. The method of claim 2, wherein the step of obtaining an understanding of the business process requirements further comprises defining a project, defining goals of the project, and defining project plan.

4. The method of claim 2, wherein the information captured is in the form of buzzwords, subject areas and other pertinent information related to the business process.

5. The method of claim 4, wherein the information captured may be information such as cycle times, backlog, turn around time by suppliers, and age of shipment.

6. The method of claim 2, wherein the step of analyzing further comprises:
defining dimensions and facts to be measured and type of measurement to be undertaken.

7. The method of claim 1, wherein the step of building the Business Intelligence system further comprises the steps of:
building a data warehouse to store data;
analyzing the business process requirements as obtained from the step of modeling;
identifying sources of various data inputs;
preparing data for loading into data warehouse;
using OLAP tools to generate Business information from the data; and
using web service applications to load the business intelligence system and distribute data to the other within an enterprise.

8. The method of claim 1, wherein the step of generating further comprises the steps of:
entering variables like database name, web server name; and
generating the business intelligence system in one shot by showing the interconnectivity of various business process life cycles within the business process.

9. The method of claim 1, wherein the step of analyzing further comprising the steps of:
providing access to data to users;
publishing scorecards for each individual Business Process lifecycle that rate the business performance from year to year; and
analyzing each individual lifecycle for progress and comparing and cross checking data for expected and achieved results.
entering input of desired corrective actions desired into the Business Intelligence system and evolving the Business Intelligence system.

10. The method of claim 7, wherein the step of building the data warehouse further comprises the steps of:
defining measures based on the metrics defined;
defining measures into base measures and derived measures;
defining dimensions based on “how to measure”;
forming a matrix of the measures and dimensions;
creating groups of base measures and derived measures that have the same dimension;
creating a matrix of dimensions and facts;
creating a matrix of dimensions and cubes;
defining attributes and unique key for the dimensions;
defining additional measures and facts attributed to the facts;
creating a data model schema;
organizing the schemas into subject areas and life cycles;
defining the data model for OLAP;
organizing the OLAP schema into life cycles and stages;
creating a staging area for the data warehouse;
identifying the source systems that contain the transaction data for the sources;
defining the mapping between the source systems to staging;
defining the mapping between data warehouse and OLAP;
defining web services so as to expose each life cycle and stage to load real time business process life cycle data into the Business Intelligence system.

11. A system for generation of a Business Intelligence system in one shot, said system comprising:
a modeler for modeling a business process by defining at least one business process lifecycle by splitting said business process lifecycle into several events and by defining its metrics and associated “how to measures”;
a builder for building the business intelligence system by interconnecting business process life cycles within the business process;
a generator for generating the business intelligence system in one shot by showing the interconnectivity of various business process life cycles within the business process; and
an analyzer for analyzing entire business processes based on the Business Intelligence system generated.

12. The system of claim 11, wherein the modeler comprises:
a project module for obtaining an understanding of the business process requirements and identifying lifecycles within the business process;
a Business Process module for identifying lifecycles within the business process and for splitting the business process into several events;
an information capture module for capturing data inputs; and
an analysis module for analyzing the information captured.

13. The system of claim 12, wherein the project module performs the steps of:
defining a project, defining goals of the project, and defining project plan.

14. The system of claim 12, wherein the information capture module captures information in the form of buzzwords, subject areas and other pertinent information related to the business process.

15. The system of claim 14, wherein the information captured may be information such as cycle times, backlog, turn around time by suppliers, and age of shipment.

16. The system of claim 11, wherein the analyzer performs the steps of:
defining dimensions and facts to be measured and type of measurement to be undertaken.

17. A method of step 11, wherein the Builder builds the Business Intelligence system and further comprises:
a model analyzer to analyze requirements of the business process as generated by the modeler;
a source module to identify the source of various data inputs;
a staging module for preparing data for loading into data warehouse;
a data warehouse module to store data;
an OLAP module to generate Business information from the data; and
web service applications module to distribute data from one application to the other.

18. The system of claim 11, wherein the generator further comprises engines for:
entering variables like database name, web server name; and
generating the entire Business Intelligence system in one shot, said Business Intelligence system including various life cycle stages and their interrelationship to one another.

19. The system of claim 11, wherein the analyzer further comprises the steps of:
a dashboard module to provide end users with information or data relevant to there roles in the business process;
an analysis module that analyzes progress or regress of business applications;
a scorecard module that rates business performance from year to year;
a reference data module that displays data grid and edits dimensions and facts;
a meta data module that adds, edits, and displays business and technical metadata;
a reporting module that reports to users on their business standing;
an alert module that provides warning signs regarding potential loopholes and dangers; and
a configuration module to administer security options for the analyzer to work.

20. The system of claim 19, wherein the dashboard module assists users with collection of data from various sources and presentation of data collected.

21. The system of claim 19, wherein the scorecard module performs the steps of: publishing scorecards for each individual Business Process lifecycle that rate the business performance from year to year.

22. The system of claim 11, wherein the modeler, builder, analyzer and generator comprise of modules and each module is also exposed as web services.
